(19) United States
(12) Patent Application Publication
(10) Pub. No.: US 2025/0002405 A1
(43) Pub. Date: Jan. 2, 2025

(54) DEVICE AND METHOD FOR PRODUCING SUPPLEMENTARY CEMENTITIOUS MATERIALS

(71) Applicant: Cemgreen APS, Hobro (DK)

(72) Inventors: Lasse Norbye Dossing, Roskilde (DK); Martin Hagsted Rasmussen, Lübeck (DE); Mogens Juhl Fons, Farup (DK)

(73) Assignee: Cemgreen APS, Roskilde (DK)

(21) Appl. No.: 18/846,515

(22) PCT Filed: Mar. 16, 2022
(86) PCT No.: PCT/EP2022/056846

§ 371 Date: Sep. 12, 2024

(51) Int. Cl. C04B 7/44; C04B 7/12; C04B 7/36; F27B 15/10; F27B 15/14; F27D 19/00

(52) U.S. Cl. CPC C04B 7/4461; C04B 7/12; C04B 7/361; C04B 7/4469; F27B 15/10; F27B 15/14; F27D 19/00; F27D 2019/0053; F27M 2003/03

(57) ABSTRACT

The present invention relates to device for heat-treating solid material, in particular in granular form, wherein the device comprises a kiln and an external heat source, wherein said device comprises at least two steps arranged above each other, wherein each step comprises a gas permeable sloped sliding surface on which a bed of said solid material slides down within said device due to gravity and wherein said sloped sliding surfaces of said steps directly consecutive to each other slope in opposite directions, wherein the kiln comprises at least one, preferably at least two, of said steps and the kiln is configured such that a hot gas generated by the external heat source is led through said solid material inside the kiln to heat said solid material to a desired temperature in order to change the substance properties of said solid material. According to the invention, said device comprises at least one gas temperature adjustment system comprising a gas outlet in a second step of said steps, a temperature adjustment zone and a gas inlet in a first step of said steps, preferably the first step being arranged directly consecutive and above the second step, wherein at least the first step is one of said at least one step inside the kiln and wherein said gas temperature adjustment system is adapted such that hot gas is extracted from said second step through the gas outlet, directed into the temperature adjustment zone where a hot gas temperature is adjusted to an adjusted temperature by the external heat source and reintroduced into said first step at said adjusted temperature. The invention further relates to a method for producing supplementary cementitious materials.

The present invention relates to a device and to a method for heat-treating solid material, in particular in granular form, to produce supplementary cementitious material (SCM).

A device according to the preamble of independent claim 1 comprises a kiln and an external heat source. Said device comprises at least two, preferably more than two, steps arranged above each other, wherein each step comprises a gas permeable sloped sliding surface on which a bed of said solid material slides down within said device due to gravity. Said sloped sliding surfaces of said steps directly consecutive to each other slope in opposite directions. The kiln comprises at least one of said steps and the kiln is configured such that a hot gas generated by the external heat source is led through said solid material inside the kiln to heat said solid material to a desired temperature in order to change the substance properties of said solid material.

The cement industry is currently forced and struggling to reduce energy consumption in general and, specifically, to reduce the associated CO2 emissions. The energy consumption for transforming limestone into cement is dictated by chemistry. Today, the cement industry uses supplementary cementitious materials in order to reduce production and energy costs thereby also reducing the CO2 emissions. The supplementary cementitious materials are usually bi-products stemming from other industries. Due to governmental regulations, many of these supplementary cementitious materials are currently being phased out, which poses a great problem to the cement industry due to an unsecure supply chain. Fly ash which is by far the most common supplementary cementitious material today, is a waste product from coal-fired power plants. Since many plants are closing down to meet the general demand for fossil fuel reduction, fly ash becomes limited and is already a very limited resource in some regions. An alternative supplementary cementitious material is a shale, clay, claystone, slate or mudstone that contains clay minerals pertaining to the Kaolin group, Smectite group, Illite group, Chlorite group or a combination thereof, which after a correct heat treatment will exhibit cementitious properties. In order to obtain the optimal SCM properties the clay minerals has to be calcined in a very narrow temperature interval, which means that the kiln gas temperature has to be controlled within a narrow interval, hence, it must be ensured that the core of the granules has experienced the required minimum temperature to become reactive and the surface of the granules has not exceeded the maximum temperature. It is essential that the heat treatment is carried out in this narrow temperature window with a specific retention time in order to obtain the right properties of the final product.

A device of the type mentioned in the beginning is known from EP 3828488 A. The device described in EP 3828488 A comprises an external heat generator that externally heats gas to the desired temperature and supplies it to the kiln.

PCT/EP2020/081722 discloses methods for producing a cement comprising a supplementary cementitious material, wherein the cement can be produced with reduced CO₂ emission and energy consumption, shows a high substitution rate of the milled cement clinker and has a reduced unwanted discoloration and increased mechanical properties, such as compressive strength, when compared to other substituted cements. However, these methods require in embodiments a very and consistent quality of the raw material of the supplementary cementitious material, such as a high concentration of pozzolanically active clay minerals and a rather specific particle size. Thus, the natural deposits of clay, shale, slate or mudstone materials, which can act as suitable raw materials for these methods, are limited. This in turn increases the production costs for producing cements with these conventional methods and may limit the possibility to economically produce cements with a consistent quality on a large-scale. Moreover, the color properties and the mechanical properties, such as the compressive strength, of the resulting cement may vary significantly and are further improvable.

Analogous considerations apply to WO2012/126696A1, which discloses a method for producing a clinker substitute for use in the cement production comprising the steps of pre-drying clay, comminuting the clay to a grain size of smaller than 2 mm, calcining the clay at a temperature of 600 to 1000° C., treating the clay under reducing conditions at a temperature of 600 to 1000° C., intermediate cooling and final cooling of the product. A major disadvantage of this method is that it requires that the raw material quality must be very high and consistent to secure a sufficient quality of the resulting SCM product and in turn the cement. Moreover, this method requires the step of treating the clay under reducing conditions in order to ensure a sufficient color of the resulting cement and is thus further improvable.

DE102010061456A1 discloses a method for producing a building material composition, which is provided as a part of a binder or as a part of building material mixture with a binding agent, wherein the method comprises the steps of (i) coarsely grinding a raw clay material, such that at least 90% of the particles comprise a particle size of at most 100 mm, and/or preferably at least 70% of the particles have a particle size of at least 10 mm, and/or that at least 90% of the particles have a particle size of at least 1 mm; (ii) calcining the coarsely grinded raw clay material at a temperature range of 650° C. to 950° C., and (iii) milling the calcined particles in that 90% to 99% of the particles have a particle size of smaller than 32 μm. Further, this document discloses a binding agent composition comprising a cement. However, this method cannot produce supplementary cementitious materials with a high and consistent quality from a huge variety of raw materials.

In turn, there exists a strong need for the provision of a method for producing a supplementary cementitious material, which can be employed in a method for producing a cement in an economic and cost efficient way, which allows a highly flexible process and a high substitution degree of the milled cement clinker, and which leads to a cement with reduced unwanted coloration and increased mechanical properties. Further, there exists a need for a method for producing a supplementary cementitious material, wherein the supplementary cementitious materials can be produced with a high and consistent quality from a huge variety of raw materials. The conventional methods for producing supplementary cementitious materials particularly do not provide sufficient results. Further, there is a need for more energy efficient production of supplementary cementitious material.

The object of the present invention is to provide a device of the type described in the beginning that allows an efficient production of supplementary cementitious material with a very precise temperature window and with an improved energy efficiency.

A further object is the provision of a method for producing a supplementary cementitious material, which can produce the supplementary cementitious material in a high and consistent quality, with high energy efficiency, low production costs and on a large-scale, even when using raw materials with poor and varying clay mineral contents.

The term “supplementary cementitious material” (or “SCM”) is defined as a material, with which cement can be substituted, i.e. partially replaced. Suitable supplementary cementitious materials may be in embodiments derived from raw materials that are selected from the group comprising clay, soil, marine clay, mudstone, claystone, shale, slate, mine tailing, oil sand and harbor sludge materials, or combinations thereof. The raw materials supplementary cementitious materials in terms of the present invention comprise in embodiments at least 20 wt. %, preferably at least 40 wt. %, clay minerals. The clay mineral content can be determined by e.g., a suitable method for measuring the acid soluble residue and/or by quantitative X-ray diffraction.

Clay materials constitute a preferred embodiment for the raw material for the supplementary cementitious material. The clay materials in terms of the present invention are defined as materials preferably comprising clay minerals belonging to the kaolin group, the smectite group, the illite group, chlorite group or combinations thereof. Suitable clay minerals of the kaolin group are e.g. kaolinite, dickite, nacrite or halloysite. Suitable further clays minerals belong to the smectite group including octahedral vermiculites such as vermiculite, dioctahedral smectites such as montmorillonite and nontronite and trioctahedral smectites such as saponite, the illite group such as illite, glauconite and brammallite or to the chlorite group such as chamosite.

In general, raw materials of a supplementary cementitious material can be classified by their molecular water content. The raw material of the supplementary cementitious material in terms of the present invention is preferably a wet sediment-like clay material, comprising at least one clay mineral that is present as agglomerates, having a primary average particle size of 10 μm or less, and having a molecular water content of at least 2 wt. %, based on the total weight of the raw material of the supplementary cementitious material. The term “primary average particle size of the clay mineral” is defined as the average particle size of de-agglomerated singular clay mineral particles.

The term “molecular water content” is defined as the sum of water that is present in the raw material of the supplementary cementitious material in molecular form, including water that is bound to the surface of the particles constituting the raw material. The molecular water content is measured by weighing the sample before and after heating of the raw material at a temperature of 110° C., applying vacuum, storing a sample in a dry environment or a combination thereof. The remaining weight loss of the sample pertains pre-dominantly to dehydroxylation and can be measured by X-ray fluorescence (XRF) spectrometer.

The molecular water content in terms of the present invention preferably differs from the parameter “loss on ignition (LOI)”. The LOI is measured by heating a sample from ambient temperature of 20° C. to 1050° C. and weighing the sample before and after heating, The LOI of suitable raw materials of the supplementary cementitious material is not particularly limited and is preferably 2-14%, more preferably 3-13%, and even more preferably 4-12%.

The wet raw material of the supplementary cementitious material has a molecular water content above 2 wt. % or more. Suitable wet raw materials of the supplementary cementitious material may be clay, soil, marine clay, mine tailing, oil sand and harbor sludge materials that are composed of agglomerated fine particles comprising hydrous aluminum phyllosilicates, Clays and soils are formed as the result of weathering and natural erosion induced by water, wind, temperature change, gravity, chemical interaction, living organisms and pressure differences. Clays and soils generally occur as non-compacted deposits. Marine clays are non-compacted or non-rock like deposits. Marine clays are the result of continental weathering since clay particles are transported with surface water by e.g. riverine input and sedimented in deltas or the marine environment as plastic sediments. Mine tailing, oil sand and harbor sludge are anthropogenic materials from different industries with varying clay mineral content.

In nature, clay minerals are found either as loose wet sediments/soils (clay) or as a dry rock (shale). Clay minerals in loose sediments/soils/deposits are either found as individual minerals sizes below 2 microns or in agglomerates with a typical size <1 cm. The agglomerates contain multiple individual minerals bound together by surface water.

The supplementary cementitious material usually comprises in embodiments oxidizable components, such as Fe, Cr, Ti, Cu, U or Mn components. The Fe content is preferably 0.500 to 20.000 wt. %. The Cr content is preferably 0.010 to 5.000 wt. %, the Ti content is preferably 0.100 to 5.000 wt. %, the Cu content is preferably 0.001 to 0.010 wt. %. The U content is preferably 0.001 to 0.100 wt. %. The Mn content is preferably 0.010 to 1.000 wt. %. The content is preferably measured with an X-ray fluorescence (XRF) spectrometer or alternatively with an inductively coupled plasma mass spectrometer (ICP-MS). These oxidizable components may cause an unwanted discoloration, when they are present at the surface of the particles during calcining.

The term “calcining” refers to a thermal treatment, usually in the presence of gas containing less oxygen than ambient air, of a given raw material in order to achieve a chemical decomposition. The calcination degree can be determined by thermogravimetry and/or DTA (e.g. Bich et al., Applied Clay Science, 44 (2009) 194-200).

The term “dehydroxylation” refers to the at least partial loss of one or more hydroxyl groups, such as water, upon heating. A dehydroxylation of the raw material of the supplementary cementitious material is achieved during calcining.

The term “pozzolanic activity” means that the supplementary cementitious material can act as a pozzolan in the cement. Pozzolanic activity is in generally known as the ability to chemically react in the presence of water with calcium hydroxide and calcium silicate hydrate at ordinary temperature in order to form compounds possessing cementitious properties.

The term “vitrification” is defined as the occurrence of melting phases and the formation of inert minerals, such as mullite, that is associated with an agglomeration of the particles, in the supplementary cementitious material. Vitrification takes place at elevated temperatures of 1000° C. or 30 higher and is to be avoided as much as possible, since it reduces the pozzolanic activity of the calcined material. In this regard, reference is made to the scientific publication “Investigation of the Effect of Heat on the Clay Minerals Illite and Montmorillonite, R.E. Grim and W.F. Bradley, Journal of the American Ceramic Society, 1940, Vol. 23, No. 8, 242-248), which clearly states that the calcining temperature of the clay materials must not exceed 980° C. in order to prevent the occurrence of vitrification.

The term “milling” in terms of the present application is used as a synonym for crushing/grinding and defines a physical process of forming particles from a solid raw material and/or of reducing the particle size of a particulate raw material. Milling means are commonly known and are e.g. roller press, ball mill, vertical roller mill, dry crusher and jaw crusher.

The term “average particle size” in terms of the present application is defined as the arithmetic average particle size as measured according to ASTM C 430-96 (2003).

A solution of the object according to the invention exists if said device comprises at least one gas temperature adjustment system comprising a gas outlet in a second step of said steps, a temperature adjustment zone and a gas inlet in a first step of said steps, preferably the first step being arranged directly consecutive and above the second step, wherein at least the first step is one of said at least one step inside the kiln and wherein said gas temperature adjustment system is adapted such that hot gas is extracted from said second step through the gas outlet, directed into a temperature adjustment zone where an hot gas temperature is adjusted to an adjusted temperature by the external heat source and reintroduced into said first step at said adjusted temperature.

One major advantage of the present invention is that the temperature in said first step can be controlled precisely to the desired temperature due to the reintroduction of hot gas at the adjusted temperature. Thus, it can be ensured that the material does not experience temperatures above the allowed maximum temperature. Furthermore, the material is not exposed to radiation from an internal burner. Further, the temperature adjustment by the gas temperature adjustment system only requires a small new energy input by the external heat source, as the temperature of the hot gas extracted from said second step is close to the desired kiln temperature.

Different heat sources may be used as external heat source. For example, the heat source may be a separate combustion unit and/or a heat exchanger and/or any other suitable heat generating device. For example, the heat source may be a device selected from the group comprising a combustion unit, electrical furnace, a solar power device, a waste heat device, a heat storage unit, a plasma burner or a combination thereof.

Preferably, the heat transfer is achieved in a cross-flow configuration, wherein the solid material moves downwards and the hot gas upwards inside the kiln. This offers the advantage that the heat transfer from the hot gas to the solid material is repeatable, can easily be controlled, and is highly efficient. It further adds to a homogenous heat treatment of the solid material.

Preferably, the sloping angle of the sloped sliding surface to the horizontal is preferably in the range of from 10° to 55°, and more preferably from 20° to 45°.

Also preferably, said sloped sliding surface is adapted to allow an isokinetic motion of said solid material along said sloped sliding surface. Isokinetic is defined as all particles in a cross-sectional view perpendicular to the transport direction, will have the same displacement within a specific time period. The main advantage of this feature is that the heat transfer is efficient, repeatable and easy to control. An isokinetic motion of the solid material is achieved if no vertical mixing of the layers of the bed of solid material occurs. Ideally, the relative position of each piece of material remains the same with regard to the neighboring piece of material while the bed of solid material slides down along the sliding surface.

The expression “solid material slides down within the kiln due to gravity” in accordance with the present invention means that the kiln is configured such that the material automatically slides down along the sloped sliding surfaces merely due to gravity and without the need of any pusher or moving means of the kiln. Consequently, the kiln preferably does not comprise any moving parts that come into contact with said solid material. This adds to a simple construction and leads to low maintenance efforts.

Advantageous embodiments of the present invention are the subject of the dependent claims.

According to a preferred embodiment of the present invention, the device further comprises a cooler section, wherein the kiln is arranged above the cooler section and wherein the cooler section comprises at least one, preferably at least two, of said steps, wherein the device comprises one of said gas temperature adjustment systems of which the second step is formed by an uppermost step of the at least one step inside the cooler section and the first step is formed by a lowermost step of the at least one step inside the kiln. Preferably, the kiln comprises at least two steps, wherein each step of the kiln is connected to the step below by means of one of said gas temperature adjustment systems. This allows the temperature to be set precisely at each step of the kiln, and this is done in a very energy-efficient manner. Since the temperature can be precisely controlled in the entire kiln, a very efficient calcination can be carried out and the process can be carried out in a very small and precise temperature window, which in turn allows a further increase in energy efficiency and optimal final SCM properties.

According to an embodiment of the present invention, said gas temperature adjustment system is adapted such that at least 50%, preferably at least 70%, more preferably at least 90%, of the hot gas that leaves said second step leaves said second step through the gas outlet. Preferably, said gas temperature adjustment system is adapted such that said adjusted temperature of the hot gas is such that said solid material in the first step is heated to said desired temperature. Due to a significant portion of the hot gas passing from the second step to the first step through the gas temperature adjustment system, the temperature in the first step can be adjusted very precisely to the desired temperature by the hot gas at the adjusted temperature entering the first step. The adjusted temperature that said gas temperature adjustment system is adapted to heat the gas to depends on the proportion of the gas that is passed through the gas temperature adjustment system. If only a smaller portion, for example slightly above 50%, is passed through the gas temperature adjustment system, the adjusted temperature may be above the desired temperature in order to achieve the desired temperature in the first step in combination with the hot gas reaching the first step via the inside of the kiln. At higher portions, the adjusted temperature will be closer to or identical with the desired temperature.

According to another preferred embodiment, the device comprises a control unit that is adapted to control the adjusted temperature to a set point in the range of in the range of 400 to 800° C., preferably in the range of 400 to 800° C., when the device is used for heat-treating solid material with more than 40 weight percent clay minerals pertaining to kaolin group, and to a set point, preferably in the range of 500 to 775° C., when the device is used for heat-treating solid material with more than 40 weight percent clay minerals pertaining to smectite group, and to a set point, preferably in the range of 600 to 800° C., when the device is used for heat-treating solid material with more than 40 weight percent clay minerals pertaining to illite group. Preferably, the control unit is connected to at least one thermocouple at the gas inlet of the at least one gas temperature adjustment system to control the hot gas temperature to the adjusted temperature. The high energy efficiency of the device makes it possible to use hot gas at significantly lower temperature values than in previously known systems and still achieve satisfactory heat treatment of the above-mentioned solid materials. This results in a large energy saving potential.

In a further preferred embodiment, said control unit is adapted to control the adjusted temperature to stay inside a temperature range of +/−40° C., preferably of +/−20° C., around said set point. This allows the material to be heat treated even better with the device.

In an another embodiment of the present invention, a compartment is arranged below said sloped sliding surface, which is part of said first step comprising said sliding surface above and to which said gas inlet of said gas temperature adjustment system is connected, wherein the device is adapted such that said hot gas, which is extracted via said gas outlet of the gas temperature adjustment system from the second step and which temperature is adjusted in the temperature adjustment zone of the gas temperature adjustment system, is introduced into said compartment of said first step and then passes through openings in said sloped sliding surface of said first step. As a result, the hot gas at the adjusted temperature can be introduced constructively easy into the first step in such a way that it can be evenly led into the solid material located in the first step. Preferably, said gas inlet is formed as an aperture in the wall of the kiln inside the compartment or as a tube with several apertures arranged on the outer surface of the tube, which projects into the compartment or which is arranged next to the compartment, such that the apertures are directed into the compartment.

In a particularly preferred embodiment of the present invention, said compartment comprises compartment walls that are dust permeable or that are sealed, wherein the compartment preferably comprises a dust extraction mechanism in case said compartment walls are sealed, wherein especially preferably said extraction mechanism comprises an extraction auger placed at a locally low situated point of the compartment. In case dust permeable compartment walls are used, dust that may have passed through the openings in the sloped sliding surface cannot accumulate in the compartment, but is passed on to the step below. This is not the case for sealed compartment walls, which have the advantage that no hot gas can enter the compartment from below. Hence, preferably for sealed compartment walls a dust extraction mechanism is arranged inside the compartment. Further, for sealed compartment walls, preferably, a bottom wall of the compartment is arranged at a slope to an outer wall of the kiln so that dust can slide down the bottom wall and be removed at a lowest point by the dust extraction mechanism.

The object is alternatively achieved by the features of claim 6. Accordingly, in the case of a device for heat-treating solid material, in particular in granular form, wherein the device comprises a kiln and an external heat source, wherein said kiln comprises at least two steps arranged above each other, wherein each step comprises a gas permeable sloped sliding surface on which a bed of said solid material slides down within said kiln due to gravity while a hot gas generated by the external heat source is led through said solid material to heat said solid material to a desired temperature in order to change the substance properties of said solid material and wherein said sloped sliding surfaces of said steps directly consecutive to each other slope in opposite directions, a solution of the object according to the invention exists if said sloped sliding surface comprises a plurality of gas permeable grate plates through which said hot gas passes, wherein said grate plates are suspended at their upper end from a support and their lower ends only rest on a further support or on the upper end of a further grate plate which is suspended from said further support. This allows a very simple and cost-effective construction of the sloped sliding surfaces, which at the same time allows the structure to react flexibly to the different expansion level of the grate plates due to temperature changes, for example, when the temperature is raised after the kiln has been switched off. The alternative solution at the same time constitutes a preferred embodiment of the solutions according to claim 1.

In a particularly preferred embodiment of the present invention, said grate plates overlap in a direction along the sloped sliding surface and preferably also in a horizontal direction, wherein preferably said grate plates are only suspended from said support on one edge of the upper end. This additionally simplifies the construction of the sloped sliding surfaces and ensures a continuous sliding surface regardless of the temperature currently present in the kiln.

According to another preferred embodiment of the present invention, said support comprises a pipe with an insulation and fins on which said grate plates are suspended from. This provides a constructively simple and robust design of the supports. The insulation improves the mechanical strength of the pipe and also minimizes the temperature fluctuations and thus the expansion and contraction of the pipes. Preferably, said pipe comprises an air inlet and an air outlet. Through these air inlet and outlet, active or passive regulation of the temperature of the pipes can be achieved, so that their mechanical strength can be further improved and they experience even smaller temperature fluctuations.

Yet according to another preferred embodiment of the present invention, vertical plates are suspended at the lowest support of said sloped sliding surface to form a channel in interaction with a wall of the kiln. This allows the passing of solid material from one of the steps to the step below to be controlled in a structurally simple manner.

According to another preferred embodiment of the present invention, the device comprises two kilns, a first kiln and a second kiln, which are arranged adjacent to each other sharing a common wall, and wherein the device comprises at least two gas temperature adjustment systems, wherein the first step of a first of the at least two gas temperature adjustment systems is one of said at least one step inside the first kiln and wherein the first step of the second of the at least two gas temperature adjustment systems is one of said at least one step inside the second kiln. This allows the height of the device to be reduced while maintaining the same possible material throughput and heat treatment.

In a further preferred embodiment, said first kiln and said second kiln comprise the same number of steps, wherein the sloped sliding surface of the at least one step inside the first kiln and the sloped sliding surface of the at least one step inside the second kiln is symmetrically arranged to said common wall, wherein sloping directions of the sloped sliding surfaces of the steps in the first kiln and the second kiln are not parallel to a plain of said common wall. This enables a particularly simple and compact design of the two kilns.

In a particularly preferred embodiment the at least one step inside the first kiln and the at least one step inside the second kiln of which an upper edge of the sloped sliding surface is arranged at said common wall comprise a compartment according to claim 7, wherein preferably said common wall comprises an opening between said compartments of the at least one step inside the first kiln and the at least one step inside the second kiln of which an upper edge of the sloped sliding surface is arranged at said common wall to form a common compartment.

The invention further relates to a method for producing supplementary cementitious material including a step of heat-treating the supplementary cementitious material by calcining a raw material of the supplementary cementitious material that preferably contains clay minerals with a device that comprises a kiln, wherein the supplementary cementitious material is led through the kiln on at least one grate plate and a hot gas at a gas temperature is led through said supplementary cementitious material inside the kiln. The method is characterized in that the hot gas is led into said supplementary cementitious material from below and through said at least one grate plate and in that the gas temperature is controlled to be inside a range of 400 to 800° C., preferably in the range of 450 to 775° C., more preferably in the range of 550 to 725° C. when heat treating supplementary cementitious material. Preferably the gas temperature is controlled to be in the Range of 400 to 800° C. when heat-treating supplementary cementitious material with more than 40 weight percent clay minerals pertaining to kaolin group, in the Range of 500 to 775° C., when heat-treating supplementary cementitious material with more than 40 weight percent clay minerals pertaining to smectite group, and in the Range of 600 to 800° C., when heat-treating supplementary cementitious material with more than 40 weight percent clay minerals pertaining to illite group.

According to the invention, air is preferably used as the gas. However, the method also may employ any other gas and particularly inert gases such as nitrogen or CO2.

By this method, the heat transfer efficiency between the hot gas and the supplementary cementitious material can be greatly improved. A reason for that is that limitations in heat transfer is minimized, as well as, the water partial pressure at the material surface is reduced to a minimum. Another reason for this is that by this method less or no supplementary cementitious material becomes entrained in the gas. The inventors have recognized that as a result of this method, the gas temperature used in the kiln can be reduced in view of the calcining temperatures of commonly known methods and the calcining of the raw material at this low temperature still achieves a sufficient dehydroxylation and thus lead to a high pozzolanic activity of the resulting supplementary cementitious material. Due to the lower gas temperature, the overall energy efficiency of the method is a lot better than for commonly known methods.

A further advantage is that calcining at this low temperature avoids a vitrification of the material. In view of this, the mechanical properties of resulting cement, such as the compressive strength, are favorable. In contrast thereto, particles of a supplementary cementitious material, which are calcined at higher temperature, show a decreased pozzolanic activity, since they cannot undergo a chemical pozzolanic reaction in the cement and become inert, but may merely act as nucleation seeds for the cement, such as commonly known for silica fumes.

The resulting high pozzolanic activity ensures that the cement shows improved mechanical properties, such as compressive strength, that particularly are higher than that of conventional substituted (or blended) cements and that are in embodiments at least comparable to an unsubstituted Portland cement. For instance, the cement may have a compressive strength of 1 to 30 MPa, preferably 5 to 25 MPa, more preferably 10 to 20 MPa after 1 day, and/or 10 to 70 MPa, preferably 15 to 60 MPa, more preferably 20 to 50 MPa after 7 days. In embodiments, the cement shows at least 50%, preferably at least 65%, more preferably at least 80% of the compressive strength of a respective unsubstituted Portland cement. In embodiments, the compressive strength of the final cement product is 50-150%, preferably 75-100%, of that of ordinary Portland cement after 28-days of curing. The compressive strength is measured according to EN 196-1:2000.

The inventive method further ensures that no unwanted discoloration (for instance a reddening or darkening) occurs during the calcining of the supplementary cementitious material or that such an unwanted discoloration at least occurs only to an acceptable extent. The unwanted discoloration occurs especially at higher calcining temperatures that are avoided by the method according to the invention.

In a preferred embodiment of the method, the device used for calcining the supplementary cementitious material is the device according to one of the claims 1 to 12. This allows the gas to be introduced into the kiln with particular energy efficiency. The adjusted temperature hereby corresponds to the gas temperature according to the inventive method.

In a further preferred embodiment of the method, the gas temperature is controlled such that the gas temperature stays inside a temperature range of +/−40° C., preferably of +/−20° C., around a set point. Due to the high energy efficiency, the temperature range can be kept very narrow, which additionally increases the product quality.

In embodiments of the method, the supplementary cementitious material has an average particle size of 1 to 1000 μm, preferably in the range of 200 to 1000 μm, more preferably 250 to 750 μm, most preferably 300 to 500 μm.

In embodiments of the method, the particle size of the final supplementary cementitious material is 1 to 100 μm, preferably 10 to 90 μm, more preferably 20 to 80 μm. The supplementary cementitious material has in embodiments a surface area using the Blaine method described in EN 196 of 100 to 30000 cm2/g, preferably 500 to 20000 cm2/g, more preferably 1000 to 18000 cm2/g, in particular 3000 to 15000 cm2/g. The determination of the surface area is performed using the Blaine method described in EN 196-6:1989.

The claimed method may comprise a milling step previously and/or subsequently to the step of calcining.

Embodiments of the present invention shall be explained in more detail hereinafter with reference to the drawings.

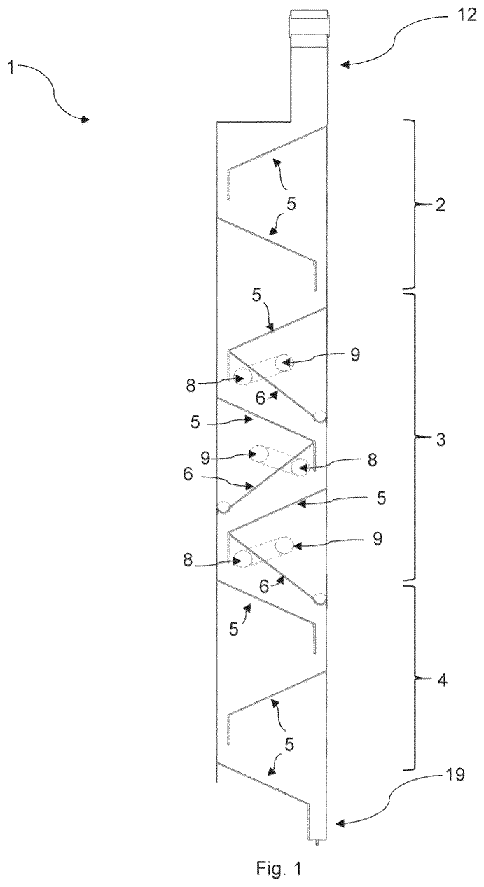

FIG. 1 shows a longitudinal section view of a device according to a first embodiment of the present invention,

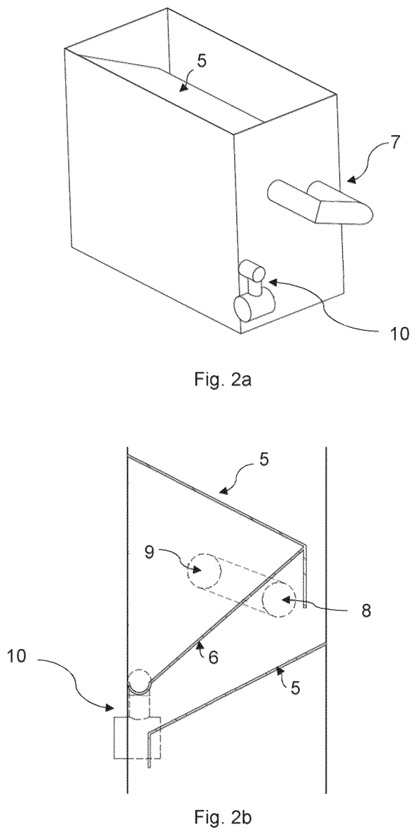

FIG. 2a shows a perspective view of a first and second step of one of the gas temperature adjustment systems of the first embodiment of the device shown in FIG. 1,

FIG. 2b shows a longitudinal section of the perspective shown in FIG. 2a,

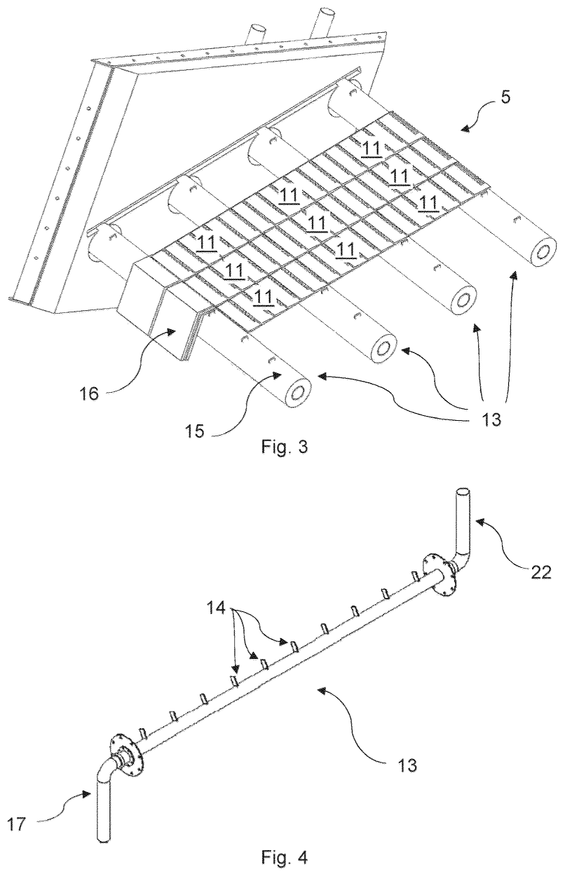

FIG. 3 shows a perspective view of several grate plates of a sloped sliding surface of a device according to the first or second embodiment mounted on several supports,

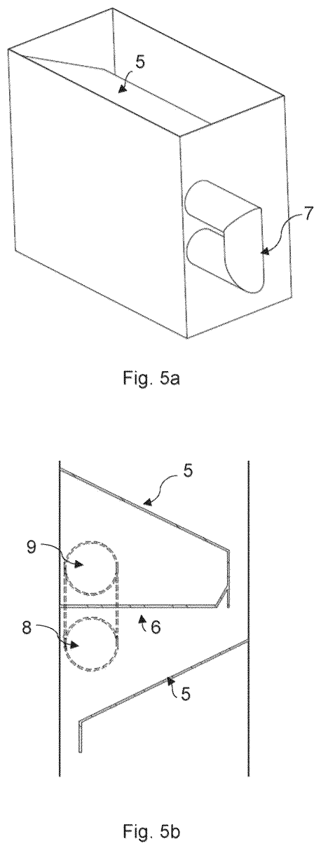

FIG. 4 shows a perspective view of a support as shown in FIG. 3 without insulation,

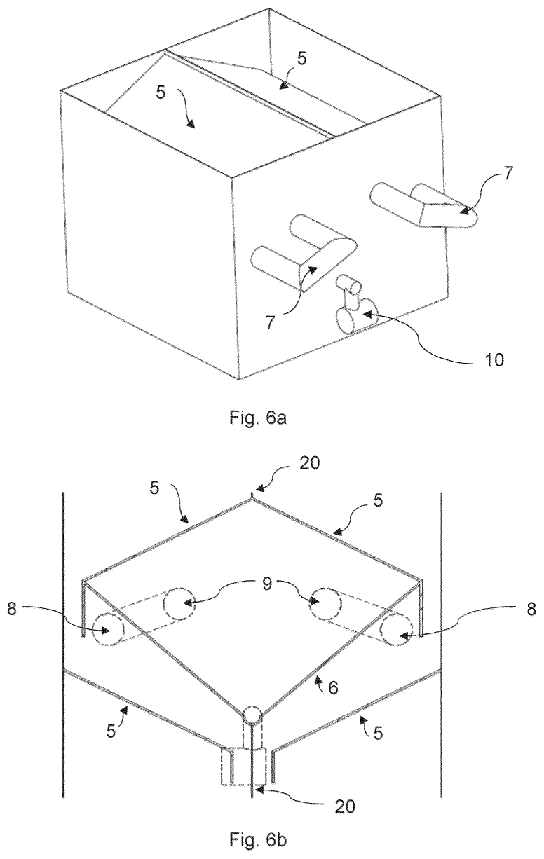

FIG. 5a shows a perspective view of a first and second step of a gas temperature adjustment system of a third embodiment of the device,

FIG. 5b shows a longitudinal section of the perspective shown in FIG. 5a,

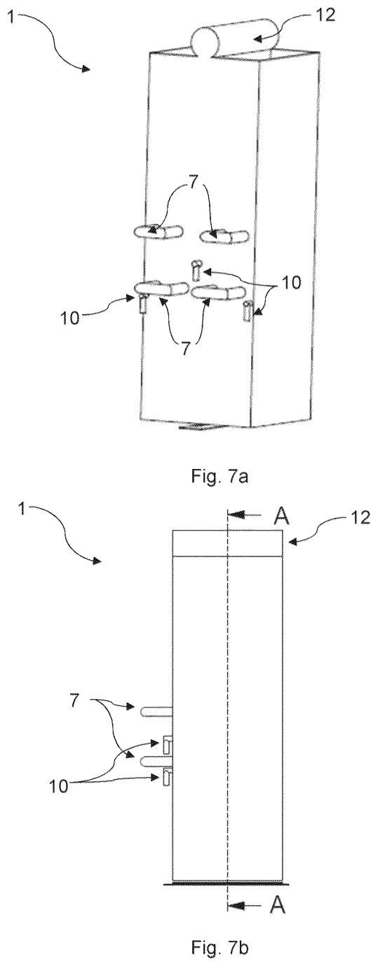

FIG. 6a shows a perspective view of a first and second step of a first gas temperature adjustment system and a first and second step of a second gas temperature adjustment system of a fourth embodiment of the device,

FIG. 6b shows a longitudinal section of the perspective shown in FIG. 6a,

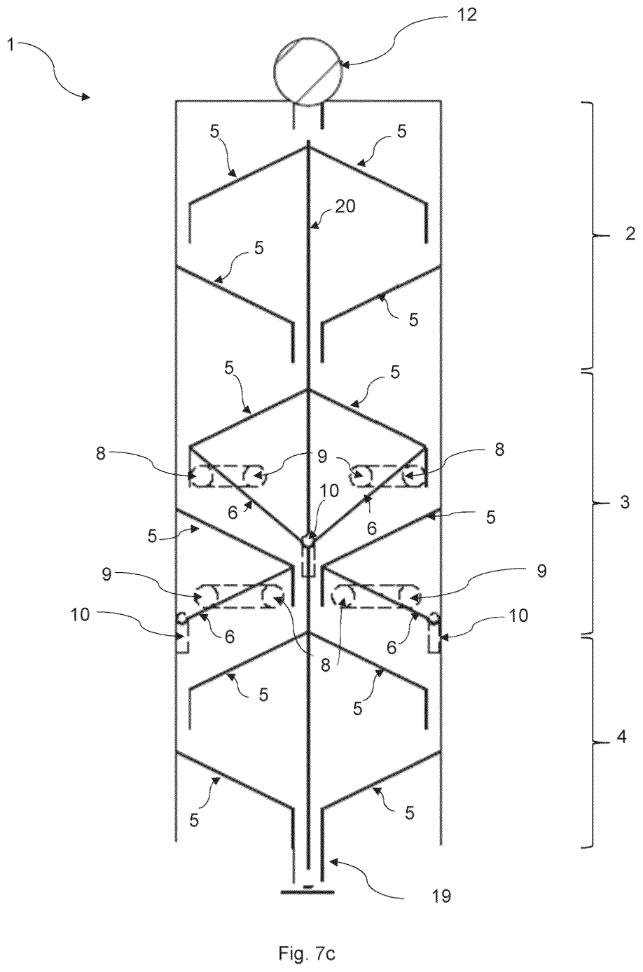

FIG. 7a shows a perspective view of another embodiment of the device,

FIG. 7b shows a side view of the embodiment of the device shown in FIG. 7a,

FIG. 7c shows a longitudinal section A of the embodiment of the device shown in FIGS. 7a and 7b, and

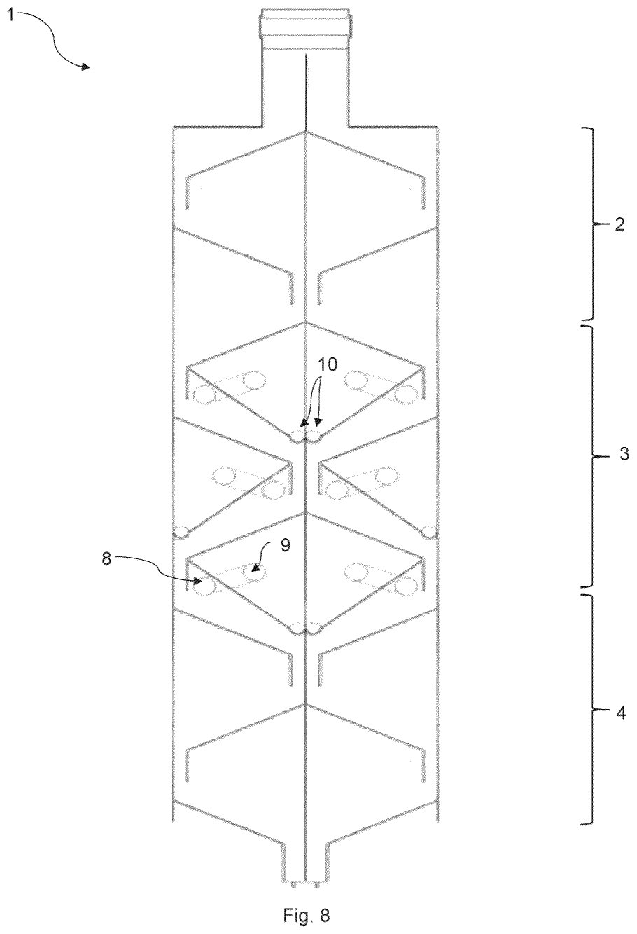

FIG. 8 shows a longitudinal section of a further embodiment of the device.

A first embodiment of a device 1 according to the present invention is shown in FIGS. 1 and 2 whereas FIG. 1 shows a longitudinal section of the first embodiment of the device 1 and FIGS. 2a and b show a perspective view and a longitudinal section of a first and second step of the kiln of the first embodiment.

The device is configured as a vertical tower with a feeding device 12 at its top end for feeding solid granular material into the device. The solid granular material, experiences a heat treatment when passing through the device such that the material is calcinated. The finished product is discharged from the device at a lower end of the tower via a suitable discharging device 19, which discharges the solid granular material at a certain controllable rate. The device 1 shown in FIG. 1 comprises an upper preheater 2, a kiln 3 in the middle, and a cooler section 4 forming a lower portion of the tower. The solid granular material is first preheated in the preheater 2, then passes on to the kiln 3 in which the calcination takes place, and is subsequently cooled down in the cooler 4 to an acceptable outlet temperature.

A plurality of opposite gas permeable sloped sliding surfaces 5 are arranged within the tower such that the solid granular material can slide down through preheater 2, kiln 3 and cooler section 4 in cascade from one sloped sliding surface 5 to another. In the exemplary embodiment, the preheater 2 comprises two sloped sliding surfaces 5 wherein the cooler section 4 and the kiln 3 comprise three sloped sliding surfaces 5 each. Each sloped sliding surface 5 represents one step of preheater 2, kiln 3 and cooler 4. As shown in FIG. 1, the kiln 3 comprises three steps, wherein the kiln steps also include a compartment below, which is formed by a compartment wall 6 and the kiln walls.

To keep the temperature at the desired temperature or within the desired temperature range inside the kiln 3, the device comprises gas temperature adjustment systems 7. An embodiment of such a system 7 is shown in FIGS. 2a and b, which show a perspective view and a longitudinal section of a section of the device 1 with a first and a second step, a gas temperature adjustment system 7 and a dust extraction device 10. The upper first step is the lowest step inside the kiln 3 and the lower second step is the uppermost step inside the cooler section 4. The gas temperature adjustment system 7 comprises a gas outlet 8, which is arranged in an area above the sloped sliding surface 5 of the second step that is considered part of the second step. The gas outlet 8 leads to a temperature adjustment zone, in which the temperature of the hot gas that is extracted from the second step via the gas outlet 8 is adjusted by an external heat source. The external heat source is not shown in the figures. Further, the gas temperature adjustment system 7 comprises a gas inlet 9 that leads into the compartment of the first step, which is arranged directly above the second step. The hot gas, which temperature was adjusted inside the temperature adjustment zone 7, is introduced into the first step via the gas inlet 9 to be introduced into the solid granular material inside the first step via gas openings in the sloped sliding surface 5 of the first step. Thereby the adjusted temperature, to which the external heat source heats the hot gas in the temperature adjustment zone, depends on the portion of hot gas that is extracted via the gas outlet 8 in comparison to the hot gas that travels from the second step to the first step inside the kiln 3. These gas temperature adjustment systems 7 connect the steps of the kiln 3 and the uppermost step of the cooler section 4 with the lowest step of the kiln in the first embodiment shown in FIGS. 1, 2a and b.

Next to the gas temperature adjustment system 7, FIG. 2a and b also show the dust extraction device 10. The compartment of the first step is sealed towards the underside by a sealed compartment wall 6. Hence, dust that enters the compartment through the gas openings in the sloped sliding surface 5 cannot leave the compartment through the bottom compartment wall 5. To prevent dust from accumulating in the compartment, the bottom compartment wall 5 is slanted so that the dust slides down into a corner. This is where the dust extraction device 10 is located, which in this embodiment consists of an extraction auger.

FIG. 3 shows a perspective view of a partly assembled sloped sliding surface 5, as used in the above-described embodiments for the sloped sliding surfaces 5 of at least the kiln 3. The sloped sliding surface 5 thereby comprises a plurality of gas permeable grate plates 11. The grate plates 11 are suspended at their upper end from a support tube 13. For the suspension, the support tubes 13 comprise fins 14 that pierce an insulation 15 of the support tubes 13. The grate plates 11 comprises a mounting point at one edge on their upper end, which can be attached to the fins 14. The lower end of an upper grate plate 11 is arranged on the upper end of a lower grate plate 11, which in turn is suspend at its upper end by another support tube 13. The lower end of the lowest row of grate plates 11 of a sloped sliding surface 5 is arranged on another component, which is suspend on the lowest support tube 13 and which comprises a vertical plate 16 that forms a channel in interaction with a wall of the kiln 3. This arrangement allows the individual grate plates 11 to move relative to each other due to temperature fluctuations without creating pressure on the outer walls of the kiln 3 and still ensuring a continuous surface of the sloped sliding surface 5. Besides, the vertical plate 16 allows a controlled transition of the solid material from one step to the next below.

FIG. 4 shows the support tubes without insulation 15. Since the support tubes 13 are fixed to the outer walls of the kiln 3, expansion due to temperature fluctuations in the kiln 3 should be avoided. For this reason and for improved mechanical stability, the support tubes 13 comprise, on the one hand, the insulation 15 and, on the other hand, as shown in particular in FIG. 6, comprise an air inlet 17 and an air outlet 18. Natural or forced convection can take place through these, so that the expansion of the support tubes 13 can be kept small.

FIG. 5a and b show a perspective view and a longitudinal section of a first and second step of a device 1 according to a second embodiment of the present invention. The device 1 comprises a gas temperature adjustment system 7 and is advantageous due to its simplicity, as the compartment below the respective sloped sliding surface 5 is constructed with a sealed horizontal compartment wall 6 and without a dust extraction device 10. Further, the gas outlet 8 of gas temperature adjustment systems 7 in the second step and the gas inlet 9 of the gas temperature adjustment systems 7 to the compartment of the first step are arranged vertically to each other, which also facilitates the construction and allows a very compact gas temperature adjustment system 7.

FIG. 6a and b show a perspective view and a longitudinal section of a first and second step of a first gas temperature adjustment system 7 and a first and second step of a second gas temperature adjustment system 7 of a fourth embodiment of the device 1 that comprises two parallel arranged kilns 3 that share a common wall 20. The sloped sliding surfaces 5 in the respective kilns 3 are arranged symmetrically to a plain of the common wall 20. Further, the first steps inside the respective kiln share a common compartment, in which the common wall 20 is interrupted and into which the gas inlets 9 of the first and second gas temperature adjustment system 7 shown in FIG. 6a and b lead into. This common compartment is also equipped with a common dust extraction device 10.

FIG. 7a, b and c show another embodiment of the device 1, wherein FIG. 7a shows a perspective view of this embodiment of the device 1, FIG. 7b shows a side view of the embodiment of the device 1 and FIG. 7c shows a longitudinal section A of the embodiment of the device that is indicated in FIG. 7b. The device 1 according to this embodiment comprises two parallel arranged preheaters 2, kilns 3 and cooler sections 4 that share a common wall 20, wherein the preheaters 2, kilns 3 and cooler sections 4 all comprise two steps and wherein the sloped sliding surfaces 5 in the respective preheaters 2, kilns 3 and cooler sections 4 are arranged symmetrically to the common wall 20. The steps inside the kiln 3 each comprise a compartment below the respective sloped sliding surface 5 and are connected via a gas temperature adjustment system 7 to the step directly below. The compartments that are arranged adjacent to the common wall 20 comprise a common dust extraction device 10. The compartments that are arranged on walls facing the common wall 20 comprise separate dust extraction devices 10. In this embodiment, the two parallel preheaters 2 are fed by one feeding device 12 and the two parallel cooler section 4 lead into one extraction device 19.

FIG. 8 shows a further embodiment of the device 1, which is similar to the embodiment shown in FIGS. 7a, b and c. The differences are that the two parallel arranged kilns 3 and cooler sections 4 have three steps each instead of two. Further, the compartments of the steps inside the kilns 3, which are arranged at the common wall 20, comprise separate dust extraction devices 10. Lastly, the gas inlet 9 of the gas temperature adjustment systems 7 is arranged slightly above the gas outlet 8 of the gas temperature adjustment systems 7 and not at the same height as for the embodiment of the device 1 shown in FIGS. 7a, b and c.

Other embodiments with two parallel kilns 3 are also possible. For example, the device 1 can also comprise only a single preheater 2 and/or only a single cooler section 4, or the parallel preheaters 2 are fed by two feeding devices 12 and the parallel cooler sections 4 lead into two discharging devices 19.

The method in accordance with the invention can be performed on a device according to FIGS. 1 to 8.

### LIST OF REFERENCE SIGNS

1 device
2 preheater
3 kiln
4 cooler section
5 sloped sliding surface
6 compartment wall
7 gas temperature adjustment systems
8 gas outlet
9 gas inlet
10 dust extraction device
11 grate plate
12 feeding device
13 support tube
14 fins
15 insulation
16 vertical plate
17 air inlet
18 air outlet
19 discharging device
20 common wall

1. Device for heat-treating solid material, in particular in granular form, wherein the device comprises a kiln and an external heat source, wherein said device comprises at least two, preferably more than two, steps arranged above each other, wherein each step comprises a gas permeable sloped sliding surface on which a bed of said solid material slides down within said device due to gravity and wherein said sloped sliding surfaces of said steps directly consecutive to each other slope in opposite directions, wherein the kiln comprises at least one, preferably at least two, of said steps and the kiln is configured such that a hot gas generated by the external heat source is led through said solid material inside the kiln to heat said solid material to a desired temperature in order to change the substance properties of said solid material,
characterized in that said device comprises at least one gas temperature adjustment system comprising a gas outlet in a second step of said steps, a temperature adjustment zone and a gas inlet in a first step of said steps, preferably the first step being arranged directly consecutive and above the second step, wherein at least the first step is one of said at least one step inside the kiln and wherein said gas temperature adjustment system is adapted such that hot gas is extracted from said second step through the gas outlet, directed into the temperature adjustment zone where a hot gas temperature is adjusted to an adjusted temperature by the external heat source and reintroduced into said first step at said adjusted temperature.

2. Device for heat-treating solid material according to claim 1, characterized in that the device further comprises a cooler section, wherein the kiln is arranged above the cooler section and wherein the cooler section comprises at least one, preferably at least two, of said steps, wherein the device comprises one of said gas temperature adjustment systems of which the second step is formed by an uppermost step of the at least one step inside the cooler section and the first step is formed by a lowermost step of the at least one step inside the kiln.

3. Device for heat-treating solid material according to claim 1 or 2, characterized in that said gas temperature adjustment system is adapted such that at least 50%, preferably at least 70%, more preferably at least 90%, of the hot gas that leaves said second step leaves said second step through the gas outlet.

4. Device for heat-treating solid material according to any one of claims 1 to 3, characterized in that said gas temperature adjustment system is adapted such that said adjusted temperature of the hot gas is such that said solid material in the first step is heated to said desired temperature.

5. Device for heat-treating solid material according to any one of claims 1 to 4, characterized in that a compartment is arranged below said sloped sliding surface, which is part of said first step comprising said sliding surface above and to which said gas inlet of said gas temperature adjustment system is connected, wherein the device is adapted such that said hot gas, which is extracted via said gas outlet of the gas temperature adjustment system from the second step and which temperature is adjusted in the temperature adjustment zone of the gas temperature adjustment system, is introduced into said compartment of said first step and then passes through openings in said sloped sliding surface of said first step.

6. Device for heat-treating solid material according to any one of claims 1 to 5, characterized in that said sloped sliding surface comprises a plurality of gas permeable grate plates through which said hot gas passes, wherein said grate plates are suspended at their upper end from a support and their lower ends only rest on a further support or on the upper end of a further grate plate which is suspended from said further support.

7. Device for heat-treating solid material according to claim 6, characterized in that said grate plates overlap in a direction along the sloped sliding surface and preferably also in a horizontal direction, wherein preferably said grate plates are only suspended from said support on one edge of the upper end.

8. Device for heat-treating solid material according to claim 6 or 7, characterized in that said support comprises a pipe with an insulation and fins on which said grate plates are suspended from, wherein said pipe preferably comprises an air inlet and an air outlet.

9. Device for heat-treating solid material according to any one of claims 6 to 8, characterized in that vertical plates are suspended at the lowest support of said sloped sliding surface to form a channel in interaction with a wall of the kiln.

10. Device for heat-treating solid material according to any one of claims 1 to 9, characterized in that the device comprises two kilns, a first kiln and a second kiln, which are arranged adjacent to each other sharing a common wall, and wherein the device comprises at least two gas temperature adjustment systems, wherein the first step of a first of the at least two gas temperature adjustment systems is one of said at least one step inside the first kiln and wherein the first step of the second of the at least two gas temperature adjustment systems is one of said at least one step inside the second kiln.

11. Device for heat-treating solid material according to claim 10, characterized in that said first kiln and said second kiln comprise the same number of steps, wherein the sloped sliding surface of the at least one step inside the first kiln and the sloped sliding surface of the at least one step inside the second kiln are symmetrically arranged to a plain of said common wall, wherein sloping directions of the sloped sliding surfaces of the steps in the first kiln and the second kiln are not parallel to a plain of said common wall.

12. Device for heat-treating solid material according to claim 11, characterized in that the at least one step inside the first kiln and the at least one step inside the second kiln of which an upper edge of the sloped sliding surface is arranged at said common wall comprise a compartment according to claim 7, wherein preferably said common wall comprises an opening between said compartments of the at least one step inside the first kiln and the at least one step inside the second kiln of which an upper edge of the sloped sliding surface is arranged at said common wall to form a common compartment.

13. Method for producing supplementary cementitious material including a step of heat-treating the supplementary cementitious material by calcining a raw material of the supplementary cementitious material that preferably contains clay minerals with a device that comprises a kiln, wherein the supplementary cementitious material is led through the kiln on at least one grate plate and a hot gas at a gas temperature is led through said supplementary cementitious material inside the kiln, characterized in that the hot gas is introduced into said supplementary cementitious material from below and through said at least one grate plate and in that the gas temperature is controlled to be inside a range of 400 to 800° C., preferably in the range of 450 to 775° C., more preferably in the range of 550 to 725° C.

14. Method according to claim 13, characterized in that the gas temperature is controlled to be in the Range of 400 to 800° C. when heat-treating supplementary cementitious material with more than 40 weight percent clay minerals pertaining to kaolin group, in the Range of 500 to 775° C., when heat-treating supplementary cementitious material with more than 40 weight percent clay minerals pertaining to smectite group, and in the Range of 600 to 800° C., when heat-treating supplementary cementitious material with more than 40 weight percent clay minerals pertaining to illite group.

15. Method according to claim 13 or 14, characterized in that the device is the device according to one of the claims 1 to 12.

16. Method according to any one of claims 13 to 15, characterized in that the gas temperature is controlled such that the gas temperature stays inside a temperature range of +/−40° C., preferably of +/−20° C., around a set point, when heat-treating the supplementary cementitious material.
